(19) United States
(12) Patent Application Publication
(10) Pub. No.: US 2021/0082140 A1
(43) Pub. Date: Mar. 18, 2021

(54) ESTIMATION DEVICE, ESTIMATION METHOD, AND COMPUTER PROGRAM PRODUCT

(71) Applicants: KABUSHIKI KAISHA TOSHIBA, Minato-ku (JP); TOSHIBA ELECTRONIC DEVICES & STORAGE CORPORATION, Minato-ku (JP)

(72) Inventors: Yusuke TAZOE, Kokubunji (JP); Yuma SANO, Setagaya (JP); Akihito SEKI, Yokohama (JP)

(73) Assignees: KABUSHIKI KAISHA TOSHIBA, Minato-ku (JP); TOSHIBA ELECTRONIC DEVICES & STORAGE CORPORATION, Minato-ku (JP)

(21) Appl. No.: 16/795,711

(22) Filed: Feb. 20, 2020

(30) Foreign Application Priority Data
Sep. 17, 2019 (JP) 2019-168062

(51) Int. Cl. G06T 7/70; G06T 7/277; G06T 3/40; H04N 5/232

(52) U.S. Cl. CPC G06T 7/70; G06T 7/277; G06T 2207/30244; H04N 5/23296; G06T 3/4007

(57) ABSTRACT

According to an embodiment, an estimation device includes one or more hardware processors configured to function as an acquisition unit, a first estimation unit, a first calculation unit, a second estimation unit, a second calculation unit, and a determination unit. The acquisition unit acquires an image captured by a camera. The first estimation unit estimates first estimation information from the image. The first calculation unit calculates first reliability of the first estimation information. The second estimation unit estimates second estimation information. The second calculation unit calculates second reliability of the second estimation information. The determination unit decides at least the position or pose of the camera from the first and second estimation information, based on the first and second reliability, and outputs at least the decided position or pose as a determination result. The second estimation unit estimates the second estimation information based on a past determination result.

### CROSS-REFERENCE TO RELATED APPLICATIONS

This application is based upon and claims the benefit of priority from Japanese Patent Application No. 2019-168062, filed on Sep. 17, 2019; the entire contents of which are incorporated herein by reference.

### FIELD

Embodiments described herein relate generally to an estimation device, an estimation method, and a computer program product.

### BACKGROUND

An estimation device is known that estimates, from an image captured by, for example, a camera mounted on a movable body, the location of the camera at the time of capturing the image, that is, the location of a movable body. The self-location estimation of a movable body sometimes fails due to various causes. In such a situation, the movable body keeps moving without recognizing the fact that the self-location estimation fails. The movable body may possibly intrude into, for example, an inherently non-travelable area. When the self-location estimation fails, the interval until the estimation becomes successful again will be a “zero-estimated” interval and, consequently, the movement trajectory of the movable body may be interrupted.

Regrettably, it is difficult for the conventional technique to estimate the location of the movable body without interrupting the movement trajectory, without using a sensor other than the camera.

### BRIEF DESCRIPTION OF THE DRAWINGS

FIG. 1 is a diagram illustrating an example of a movable body in a first embodiment;

FIG. 2 is a diagram illustrating an example of the functional configuration of the movable body in the first embodiment;

FIG. 3 is a flowchart illustrating an example of an estimation method in the first embodiment;

FIG. 4 is a diagram illustrating an example of the functional configuration of a processing unit in an estimation device in a second embodiment;

FIG. 5 is a flowchart illustrating an example of an estimation method in the second embodiment;

FIG. 6 is a diagram illustrating an example of the functional configuration of a processing unit in the estimation device in a third embodiment;

FIG. 7 is a flowchart illustrating an example of an estimation method in the third embodiment; and

FIG. 8 is a diagram illustrating an example of the hardware configuration of the estimation device in the first to third embodiments.

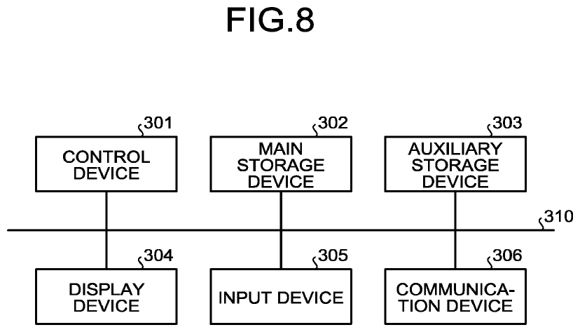

### DETAILED DESCRIPTION

According to an embodiment, an estimation device includes one or more hardware processors configured to function as an acquisition unit, a first estimation unit, a first calculation unit, a second estimation unit, a second calculation unit, and a determination unit. The acquisition unit acquires an image captured by a camera. The first estimation unit estimates first estimation information from the image. The first calculation unit calculates first reliability indicating reliability of the first estimation information. The second estimation unit estimates second estimation information. The second calculation unit calculates second reliability indicating reliability of the second estimation information. The determination unit decides at least one of the position and the pose of the camera from the first estimation information and the second estimation information, based on the first reliability and the second reliability, and outputs the decided at least one of the position and the pose as a determination process result. The second estimation unit estimates the second estimation information based on a past determination process result by the determination unit. The estimation device, an estimation method, and a computer program product according to embodiments will be described below with reference to the accompanying drawings.

### First Embodiment

An estimation device in a first embodiment is mounted on, for example, a movable body.

Example of Movable Body

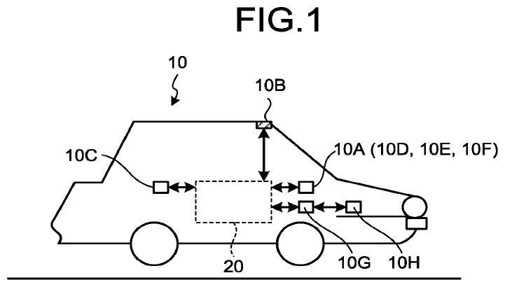

FIG. 1 is a diagram illustrating an example of a movable body 10 in the first embodiment.

The movable body 10 includes an estimation device 20, an output unit 10A, a camera 10B, a sensor 10C, a power control unit 10G, and a power unit 10H.

The movable body 10 may be any movable body. Examples of the movable body 10 include a vehicle, a carriage, and a movable robot. Examples of the vehicle include a motorcycle, an automobile, and a bicycle. The movable body 10 may be, for example, a movable body running through a human driving operation or may be a movable body capable of automatically driving (autonomous driving) without a human driving operation.

The estimation device 20 is implemented, for example, by dedicated or general-purpose computer hardware. The estimation device 20 estimates the location indicating at least one of the position and the pose of the movable body 10. Specifically, the estimation device 20 calculates the reliability for each of the self-location estimation results obtained by different methods and compares the reliability with a preset threshold to select or integrate the self-location estimation results. This configuration can eliminate the interruption in tracking of the movable body 10.

The estimation device 20 is not necessarily mounted on the movable body 10. The estimation device 20 may be mounted on a stationary object. The stationary object is, for example, an object unable to move, such as an object fixed to the ground. Examples of the stationary object fixed to the ground include a guard rail, a pole, a parked vehicle, and a road sign. For example, the stationary object is an object stationary relative to the ground. The estimation device 20 may be installed in a cloud server that executes processing on a cloud system.

The power unit 10H is a drive device mounted on the movable body 10. Examples of the power unit 10H include an engine, a motor, and a wheel.

The power control unit 10G controls the power unit 10H. The power unit 10H is driven under the control of the power control unit 10G.

The output unit 10A outputs information. In the first embodiment, the output unit 10A outputs estimation result information indicating the estimation result of motion of the camera 10B estimated by the estimation device 20.

The output unit 10A includes, for example, a communication function of transmitting estimation result information, a display function of displaying estimation result information, and a sound output function of outputting sound indicating estimation result information. The output unit 10A includes, for example, at least one of a communication unit 10D, a display 10E, and a speaker 10F. In the first embodiment, the output unit 10A includes the communication unit 10D, the display 10E, and the speaker 10F, by way of example.

The communication unit 10D transmits estimation result information to another device. For example, the communication unit 10D transmits estimation result information to another device through a communication line. The display 10E displays information on the estimation result. Examples of the display 10E include a liquid crystal display (LCD), a projector, and a light. The speaker 10F outputs sound indicating information on the estimation result.

Examples of the camera 10B include a monocular camera, a stereo camera, a fisheye camera, and an infrared camera. Any number of cameras 10B may be provided. The image taken may be a color image composed of three channels R, G, and B or may be a monochrome image of one channel represented by gray scales. The camera 10B captures time-series images of the neighborhood of the movable body 10. The camera 10B captures time-series images, for example, by capturing images of the neighborhood of the movable body 10 in time series. The neighborhood of the movable body 10 is, for example, a region in a predetermined range from the movable body 10. This range is, for example, a range that can be imaged by the camera 10B.

In the first embodiment, the camera 10B is mounted such that the front of the movable body 10 is included as the imaging direction. That is, in the first embodiment, the camera 10B captures images of the front of the movable body 10 in time series.

The sensor 10C is a sensor that measures measurement information. Examples of the measurement information include the speed of the movable body 10 and the steering angle of the steering wheel of the movable body 10. Examples of the sensor 10C include an inertial measurement unit (IMU), a speed sensor, and a steering angle sensor. The IMU measures measurement information including three-axis acceleration and three-axis angular velocity of the movable body 10. The speed sensor measures the speed from the amount of rotation of a tire. The steering angle sensor measures the steering angle of the steering wheel of the movable body 10.

An example of the functional configuration of the movable body 10 in the first embodiment will now be described in detail.

Example of Functional Configuration

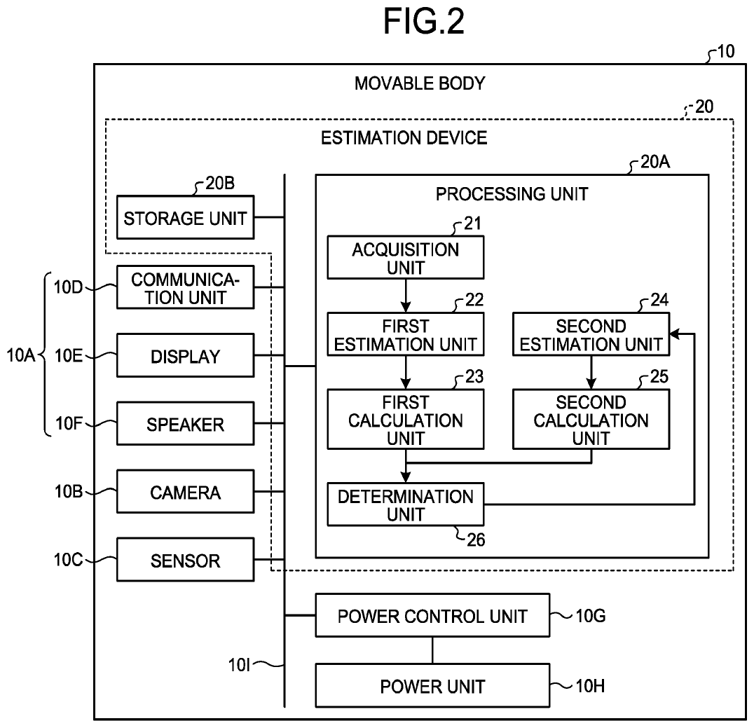

FIG. 2 is a diagram illustrating an example of the functional configuration of the movable body 10 in the first embodiment.

The movable body 10 includes an estimation device 20, an output unit 10A, a camera 10B, a sensor 10C, a power control unit 10G, and a power unit 10H. The estimation device 20 includes a processing unit 20A and a storage unit 20B. The output unit 10A includes a communication unit 10D, a display 10E, and a speaker 10F.

The processing unit 20A, the storage unit 20B, the output unit 10A, the camera 10B, the sensor 10C, and the power control unit 10G are connected through a bus 10I. The power unit 10H is connected to the power control unit 10G.

The output unit 10A (the communication unit 10D, the display 10E, and the speaker 10F), the camera 10B, the sensor 10C, the power control unit 10G, and the storage unit 20B may be connected through a network. The communication system of the network used for the connection may be wired or may be wireless. The network used for the connection may be implemented by a combination of a wired system and a wireless system.

The storage unit 20B stores information. Examples of the storage unit 20B include a semiconductor memory device, a hard disk, and an optical disc. Examples of the semiconductor memory device include a random access memory (RAM) and a flash memory. The storage unit 20B may be a storage device provided on the outside of the estimation device 20. The storage unit 20B may be a storage medium. Specifically, the storage medium may store or temporarily store a computer program and a variety of information downloaded through a local area network (LAN) or the Internet. The storage unit 20B may be configured with a plurality of storage media.

The processing unit 20A includes an acquisition unit 21, a first estimation unit 22, a first calculation unit 23, a second estimation unit 24, a second calculation unit 25, and a determination unit 26. The acquisition unit 21, the first estimation unit 22, the first calculation unit 23, the second estimation unit 24, the second calculation unit 25, and the determination unit 26 are implemented, for example, by one or more processors.

For example, the processing unit 20A may be implemented by allowing a processor such as a central processing unit (CPU) to execute a computer program, that is, by software. For example, the processing unit 20A may be implemented by a processor such as a dedicated integrated circuit (IC), that is, by hardware. For example, the processing unit 20A may be implemented by software and hardware in combination.

The term “processor” used in the present embodiment includes CPU, graphical processing unit (GPU), application specific integrated circuit (ASIC), and programmable logic device. Examples of the programmable logic device include simple programmable logic device (SPLD), complex programmable logic device (CPLD), and field programmable gate array (FPGA).

The processor reads and executes a computer program stored in the storage unit 20B to implement the processing unit 20A. A computer program may be directly built in a circuit of the processor, rather than storing a computer program in the storage unit 20B. In this case, the processor reads and executes the computer program built in the circuit to implement the processing unit 20A.

The functions of the processing unit 20A will now be described. The acquisition unit 21 acquires an image captured by the camera 10B.

When accepting an image from the acquisition unit 21, the first estimation unit 22 estimates at least one of the position and the pose of the camera 10B from the image and outputs the estimated at least one of the position and the pose as first estimation information.

The first calculation unit 23 calculates first reliability indicating the reliability of the first estimation information.

The second estimation unit 24 estimates at least one of the position and the pose of the camera 10B based on the past determination process result by the determination unit 26 and outputs the estimated at least one of the position and the pose as second estimation information. For example, the second estimation unit 24 performs estimation by applying Kalman filtering to the past determination process result output by the determination unit 26 and performing linear interpolation of the position and pose of the camera 10B at present.

The second calculation unit 25 calculates second reliability indicating the reliability of the second estimation information.

The determination unit 26 decides at least one of the position and the pose of the camera 10B from the first estimation information and the second estimation information, based on the first reliability and the second reliability, and outputs the decided at least one of the position and the pose as a determination process result.

Example of Estimation Method

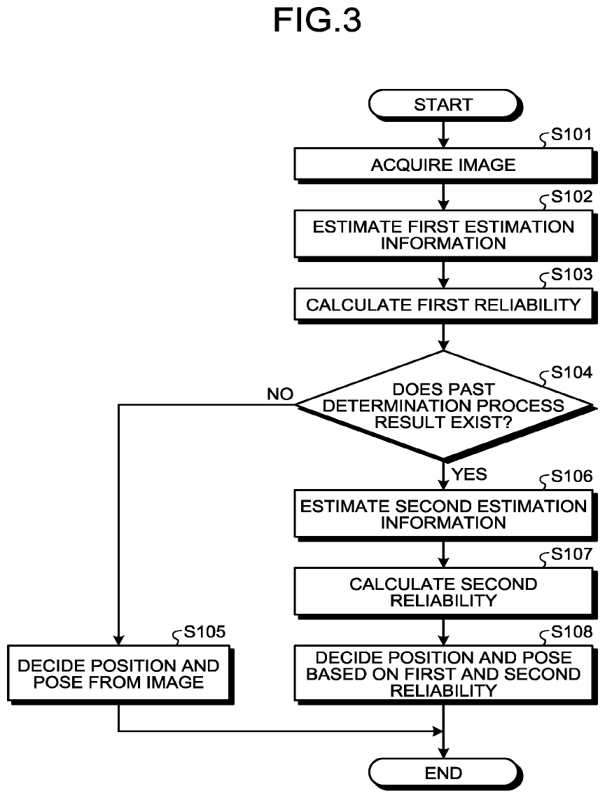

FIG. 3 is a flowchart illustrating an example of the estimation method in the first embodiment. Although in the description of FIG. 3 the estimation device 20 estimates both of the position and the pose of the camera 10B, the estimation device 20 may estimate one of the position and the pose of the camera 10B. That is, the estimation device 20 may estimate at least one of the position and the pose of the camera 10B. This is applicable to the second and third embodiments described later.

First, the acquisition unit 21 acquires an image captured by at least one or more cameras 10B (step S101).

Next, the first estimation unit 22 estimates the first estimation information using the image captured by the process at step S101 (step S102).

Specifically, the first estimation unit 22 extracts a plurality of feature points from images and performs matching between the images to estimate the position and the pose of the camera 10B at the time when each image is captured. Specifically, the position and the pose of the camera 10B at the time when each image is captured can be estimated by applying Structure from Motion (SfM) from a plurality of images obtained from the camera 10B mounted on the movable body 10.

Alternatively, for example, the first estimation unit 22 may apply Simultaneous Self-location and Mapping (SLAM) to an image acquired by the camera 10B to estimate the position and the pose of the camera 10B at the time when the image is captured. Specifically, the position and the pose can be calculated based on elementary matrices, fundamental matrices, or nomography matrices, using a plurality of sets of camera coordinates of feature points. A plurality of feature point sets can be obtained by performing matching of the feature points between the images. The matching can be implemented by, for example, template matching, the Lucas-Kanade method, and SIFT. In this case, in order to obtain the absolute scale, for example, a process of normalizing the norm of a translation vector to 1 may be performed, or the scale may be determined by an acceleration sensor or a gyro sensor.

Any method may be used for representation of the position and the pose of the camera 10B. The position and the pose of the camera 10B may be represented, for example, by a combination of quaternions representing the coordinates and rotation in a three-dimensional space. When it can be assumed that a movement is made on a plane, for example, movement on the floor, the position and the pose can be represented by three degrees of freedom, that is, two degrees of freedom for translation and one degree of freedom for rotation. For example, rotation matrices, vectors representing the rotation of axis and the rotation direction, and Euler angles may be used for representing the pose in a three-dimensional space, instead of the quaternions.

A method of estimation without feature points may be used as another method of estimating the camera pose. As a specific method, for example, camera pose estimation by a deep learning model having a network for estimating the depth from an input image and a network for estimating a camera pose may be used.

Next, the first calculation unit 23 calculates the first reliability (step S103).

The method of calculating the first reliability can be implemented, for example, by the quaternions that represent the rotation components of the estimated pose of the camera 10B by four components. In this case, it may be defined that the reliability is high if the value of qw (=cos\hat{ }2(θ/2) or 1-qw of the rotation components is large.

Translation may be used that represents the translation components of the estimated pose of the camera 10B by three variables. This case focuses on the movement in two dimensions for the x direction and the z direction in the global coordinate system, and it may be defined that the first reliability is high if the coefficient in the first term of an expression of n degrees fitted based on the amount of movement is large.

Next, the determination unit 26 determines whether the past determination process result by the determination unit 26 exists (step S104).

If the past determination process result does not exist (No at step S104), the determination unit 26 decides the position and the pose of the camera 10B directly from the image acquired by the process at step S101 (step S105). The position and the pose of the camera 10B may be decided, for example, by a method equivalent to the process by the first estimation unit 22 (the process at step S102) or using a method differing from the process by the first estimation unit 22. For example, when the same method as the process by the first estimation unit 22 (the process at step S102) is used, the determination unit 26 decides the final position and pose of the camera 10B by using the first estimation information.

If the past determination process result exists (Yes at step S104), the second estimation unit 24 estimates the second estimation information using the past determination process result by the determination unit 26 (step S106). Specifically, the second estimation unit 24 estimates the position and the pose at present by filtering using the position and the pose included in the past determination process result as inputs. For example, Kalman filtering may be used as the filtering. The second estimation unit 24 may apply Kalman filtering to the past determination process result (for example, when the position and the pose of the camera 10B up to the previous frame estimated by the first estimation unit 22 are selected by the determination unit 26, such position and pose) and calculate the position and the pose of the camera for the present frame by linear interpolation.

Next, the second calculation unit 25 calculates the second reliability (step S107).

The method of calculating the second reliability can be implemented, for example, using the quaternions that represent the rotation components of the estimated camera pose by four components. In this case, it may be defined that the reliability is high if the value of qw (=cos\hat{ }2(θ/2) or 1−qw of the rotation components is large. Translation may be used that represents the translation components of the estimated camera pose by three variables. In this case, it may be defined that the reliability is high if the first term in the approximation expression of degree 2 obtained from the amounts of movement of Tx and Tz is large.

Next, the determination unit 26 decides the position and the pose of the camera 10B from the first estimation information and the second estimation information, based on the first reliability and the second reliability (step S108). Specifically, the determination unit 26 may determine either estimation information as the determination process result (final output result), based on the first reliability and the second reliability. For example, when estimation is performed in the first estimation unit 102 and the first reliability is larger than a threshold (first threshold), the determination unit 26 may determine the first estimation information as the final output result. For example, when the first reliability is equal to or smaller than a threshold, the determination unit 26 may refer to the second reliability and, if the second reliability is larger than a threshold (second threshold), may determine the second estimation information as the final output result. For example, when the first reliability is equal to or smaller than a threshold and the second reliability is equal to or smaller than a threshold, the determination unit 26 outputs no determination process result.

For example, when the first reliability is larger than a threshold and the second reliability is larger than a threshold, the determination unit 26 decides the position and the pose of the camera 10B by a new position and pose obtained by integrating the first estimation information and the second estimation information and outputs the decided position and pose as a determination process result.

A specific method of integrating the first estimation information and the second estimation information is described. For example, the determination unit 26 integrates a translation component of the camera 10B included in the first estimation information and a translation component of the camera 10B included in the second estimation information by the weighted mean based on the first reliability and the second reliability. For example, the determination unit 26 integrates a rotation component of the camera 10B included in the first estimation information and a rotation component of the camera 10B included in the second estimation information by spherical linear interpolation based on the first reliability and the second reliability.

The threshold for reliability (determination threshold) can be set as desired by the user and may be a constant represented by the floating-point system, for example, such as 0.9997. The same threshold may be set for the first reliability and the second reliability or different thresholds may be set. For example, when the first reliability is used as the main estimation method, a lower threshold may be set for the first reliability. When the first reliability does not exceed the threshold, the threshold for the second reliability may be set to 0 such that the estimation information by the second estimation unit is always employed as the output result.

As described above, in the estimation device 20 in the first embodiment, the acquisition unit 21 acquires an image captured by the camera 10B. The first estimation unit 22 estimates first estimation information indicating at least one of the position and the pose of the camera 10B from the image. The first calculation unit 23 calculates first reliability indicating the reliability of the first estimation information. The second estimation unit 24 estimates second estimation information indicating at least one of the position and the pose of the camera 10B. The second calculation unit calculates second reliability indicating the reliability of the second estimation information. The determination unit 26 decides at least one of the position and the pose of the camera 10B from the first estimation information and the second estimation information, based on the first reliability and the second reliability, and outputs the decided at least one of the position and the pose as a determination process result. The second estimation unit 24 estimates second estimation information based on the past determination process result by the determination unit 26.

With this configuration, the estimation device 20 in the first embodiment can estimate the location without interrupting the movement trajectory, without using a sensor other than the camera 10B. For example, the location of the movable body 10 equipped with the camera 10B can be estimated without interruption in the movement trajectory.

### Second Embodiment

A second embodiment will now be described. In a description of the second embodiment, a description similar to the first embodiment is omitted and the points differing from the first embodiment will be described. In the second embodiment, the position and the pose of the camera 10B that captures an image are estimated from the image by two different methods.

Example of Functional Configuration

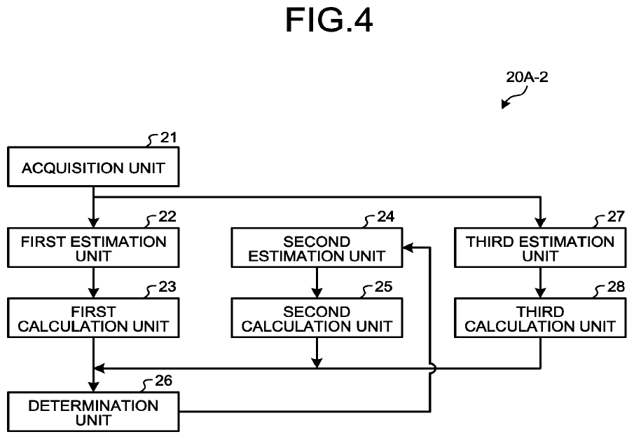

FIG. 4 is a diagram illustrating an example of the functional configuration of a processing unit 20A-2 in the estimation device 20 in the second embodiment. The processing unit 20A-2 includes an acquisition unit 21, a first estimation unit 22, a first calculation unit 23, a second estimation unit 24, a second calculation unit 25, a determination unit 26, a third estimation unit 27, and a third calculation unit 28. That is, in the second embodiment, the third estimation unit 27 and the third calculation unit 28 are added to the configuration of the first embodiment.

When accepting an image from the acquisition unit 21, the third estimation unit 27 estimates the position and the pose of the camera 10B from the image by a method differing from the first estimation unit 22 and outputs the estimated position and pose as third estimation information. For example, when the first estimation unit 22 applies SfM to a plurality of images to estimate the position and the pose of the camera 10B at the time when each image is captured, the third estimation unit 27 applies SLAM to an image to estimate the position and the pose of the camera 10B at the time when the image is captured.

The third calculation unit 28 calculates third reliability indicating the reliability of the third estimation information.

The determination unit 26 decides the position and the pose of the camera 10B from the first estimation information, the second estimation information, and the third estimation information, based on the first reliability, the second reliability, and the third reliability. The first to third reliability (or the first to third reliabilities are) is calculated based on at least one of the value of a rotation component of the pose of the camera 10B and the amount of movement of a translation component of the camera 10B.

Example of Estimation Method

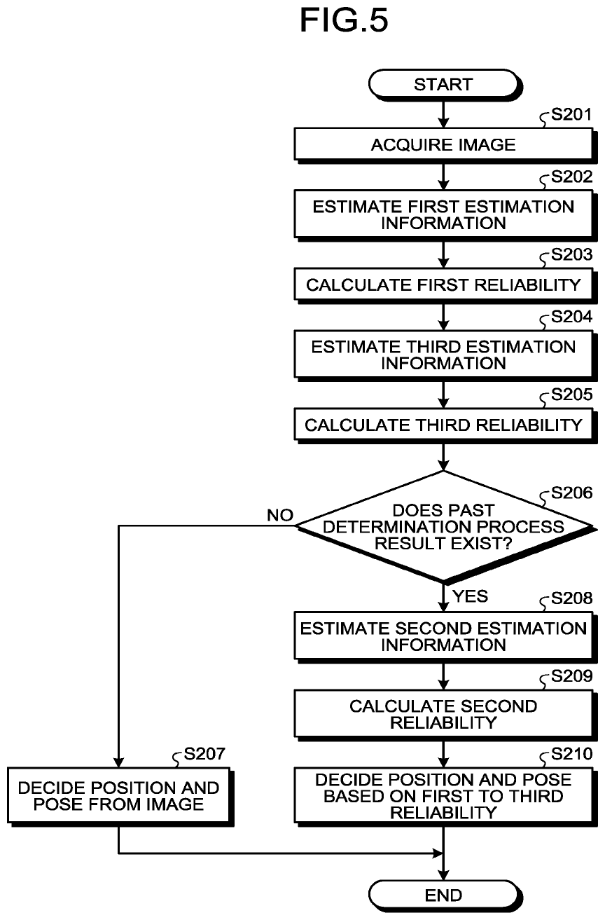

FIG. 5 is a flowchart illustrating an example of the estimation method in the second embodiment.

The processes at step S201 to step S203 are similar to the processes at step S101 to step S103 in the first embodiment and will not be further elaborated.

The third estimation unit 27 uses the image captured by the process at step S201 and estimates the position and the pose of the camera 10B by a method differing from the first estimation unit 22 to estimate the third estimation information (step S204).

Next, the third calculation unit 28 calculates the third reliability (step S205). The method of calculating the third reliability is similar to the method of calculating the first reliability and will not be further elaborated.

Next, the determination unit 26 determines whether the past determination process result by the determination unit 26 exists (step S206).

If the past determination process result does not exist (No at step S206), the determination unit 26 decides the position and the pose of the camera 10B directly from the image acquired by the process at step S201 (step S207). The position and the pose of the camera 10B may be decided, for example, by a method equivalent to the process by the first estimation unit 22 (the process at step S202) or the process by the third estimation unit 27 (the process at step S204), or using a method differing from the process by the first estimation unit 22 or the third estimation unit 27. For example, the determination unit 26 may compare the first reliability with the third reliability and decide the final position and pose of the camera 10B by the process result with higher reliability. For example, when the same method as the process by the first estimation unit 22 (the process at step S202) is used, the determination unit 26 decides the final position and pose of the camera 10B by using the first estimation information.

If the past determination process result exists (Yes at step S206), the second estimation unit 24 estimates the second estimation information using the past determination process result by the determination unit 26 (step S208).

Next, the second calculation unit 25 calculates the second reliability (step S209).

Next, the determination unit 26 decides the position and the pose of the camera 10B from the first estimation information, the second estimation information, and the third estimation information, based on the first reliability, the second reliability, and the third reliability (step S210). Specifically, the determination unit 26 may determine any one of the estimation information as the final output result, based on the first reliability, the second reliability, and the third reliability. For example, when estimation is performed in the first estimation unit 202 and the first reliability is equal to or larger than a threshold, the determination unit 26 may determine the first estimation information as the final output result. For example, when the first reliability is equal to or smaller than a threshold, the determination unit 26 may refer to the third reliability and, if the third reliability is equal to or larger than a threshold, may determine the third estimation information as the final output result. For example, when the third reliability is also equal to or smaller than a threshold, the determination unit 26 may determine the second estimation information as the final output result.

For example, as another integrating method, the determination unit 26 may integrate the respective estimation information based on the first reliability and the third reliability and determine a new position and pose of the camera 10B as the final output result. Specifically, for the translation components represented by three variables, the determination unit 26 may calculate new translation components by the linear weighted mean using the first estimation information and the third estimation information. For the rotation components represented by four components by quaternions, the determination unit 26 may focus on 0, which is the common term in four variables of the rotation components, and calculate new rotation components by spherical linear interpolation (SLERP).

The threshold for reliability can be set as desired by the user and may be a constant represented by the floating-point system, for example, such as 0.9997. The same threshold may be set for the first reliability, the second reliability, and the third reliability, or different thresholds may be set. For example, when the first reliability and the third reliability are used as the main estimation method, lower thresholds may be set for the first reliability and the third reliability. When the first reliability and the third reliability do not exceed the threshold, the threshold for the second reliability may be set to 0 such that the estimation information by the second estimation unit is always employed as the output result.

As described above, the estimation device 20 in the second embodiment can estimate the position and the pose of the movable body 10, and further based on the third estimation information having the third reliability.

### Third Embodiment

A third embodiment will now be described. In a description of the third embodiment, a description similar to the second embodiment is omitted, and the points differing from the second embodiment will be described. In the third embodiment, control of saving or discarding the position and the pose of the camera 10B determined by the determination unit 26 is described.

Example of Functional Configuration

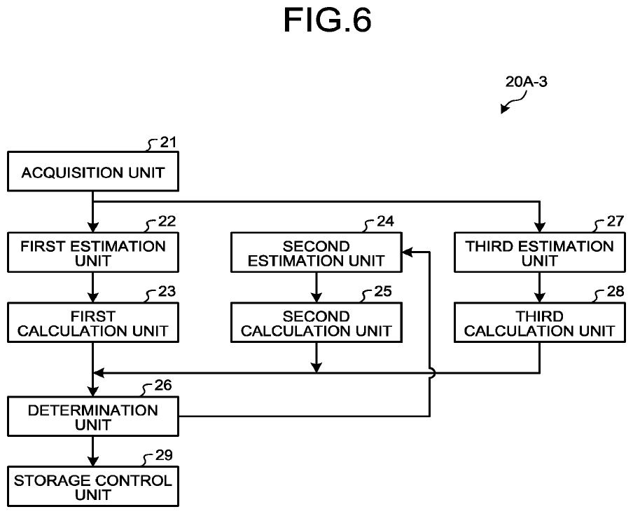

FIG. 6 is a diagram illustrating an example of the functional configuration of a processing unit 20A-3 in the estimation device 20 in the third embodiment. The processing unit 20A-3 includes an acquisition unit 21, a first estimation unit 22, a first calculation unit 23, a second estimation unit 24, a second calculation unit 25, a determination unit 26, a third estimation unit 27, a third calculation unit 28, and a storage control unit 29. That is, in the third embodiment, the storage control unit 29 is added to the configuration of the second embodiment.

The storage control unit 29 stores the estimation result including time-series information at the time of image capturing and the determination process result into the storage unit 20B. The time-series information at the time of image capturing is, for example, the number that identifies an image (for example, frame number). The determination process result includes the most-recent position and pose of the camera 10B decided by the determination unit 26.

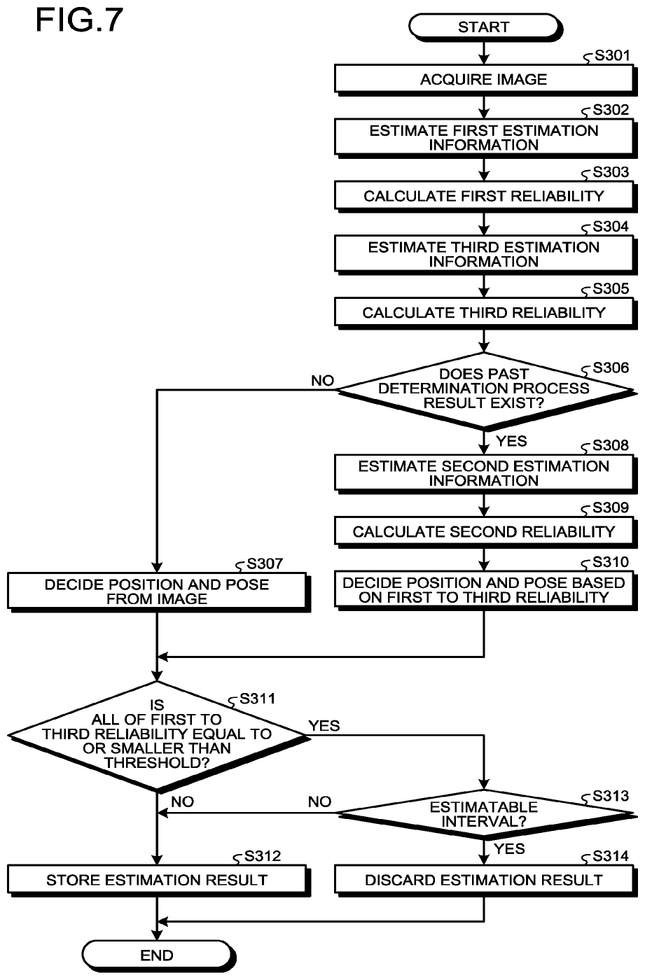

When all of the first to third reliability is equal to or smaller than a threshold and an interval for which the position and the pose of the camera 10B are not output does not exceed an estimatable interval, the storage control unit 29 discards the above-noted estimation result. The detail of storage control by the storage control unit 29 and the estimatable interval will be described later with reference to the flowchart in FIG. 7.

Example of Estimation Method

FIG. 7 is a flowchart illustrating an example of the estimation method in the third embodiment.

The processes at step S301 to step S310 are the same as the processes at step S201 to step S210 in the first embodiment and will not be further elaborated.

The storage control unit 29 determines whether all of the first to third reliability is equal to or smaller than a threshold (step S311).

If all of the first to third reliability is not equal to or smaller than a threshold (No at step S311), the storage control unit 29 stores the estimation result including the position and pose decided by the process at step S310, the time-series information at the time of image capturing, and the integration determination process result into the storage unit 20B (step S312).

If all of the first to third reliability is equal to or smaller than a threshold (Yes at step S311), the storage control unit 29 determines whether within the estimatable interval of the position and the pose of the camera 10B (the valid interval for which the previously stored determination process result is valid) (step S313).

The estimatable interval is a length of time series in which the estimation device 20 can estimate the position and the pose of the camera 10B. The length of time series may be represented, for example, by the number of frames of images or may be the time (timestamp) corresponding to a frame number. That is, when the interval since the estimation information is saved last time does not exceed this estimatable interval (Yes at step S313), the storage control unit 29 discards the estimation result (step S314). When the estimatable interval is exceeded (No at step S313), the estimation result is stored into the storage unit 20B (step S312).

Specifically, for example, when the estimation result is stored into the storage unit 20B in the n^{th} frame after the storage control unit 29 starts estimation, and the estimatable interval of the estimation device 20 is five frames, the estimation result can be discarded from the (n+1)^{th} to (n+4)^{th} frames.

On the other hand, if the position and the pose of the camera 10B saved up to n+5 frames are not updated, the storage control unit 29 stores the estimation result (the position and the pose of the camera 10B) into the storage unit 20B, irrespective of the reliability. The position and the pose of the camera 10B in this case may be any one of the position and the pose of the camera 10B estimated by the first estimation unit 22, the second estimation unit 24, and the third estimation unit 27 or may be a new position and pose obtained by integrating the respective position and pose results.

As described above, in the estimation device 20 in the third embodiment, when any of the first to third reliability is larger than a determination threshold, the storage control unit 29 stores the determination process result. When all of the first to third reliability is equal to or smaller than a determination threshold and an interval for which the position and the pose of the camera 10B are not updated is within a valid interval for which the previously stored determination process result is valid, the storage control unit 29 discards the determination process result determined this time. When all of the first to third reliability is equal to or smaller than a determination threshold and an interval for which the position and the pose of the camera 10B are not updated exceeds the valid interval, the storage control unit 29 stores the determination process result determined this time.

With this configuration, the estimation device 20 in the third embodiment can estimate the location of the movable body 10 (at least one of the position and the pose) without interrupting the movement trajectory, without using a sensor other than the camera 10B.

Lastly, an example of the hardware configuration of the estimation device 20 in the first to third embodiments is described.

Example of Hardware Configuration

FIG. 9 is a diagram illustrating an example of the hardware configuration of the estimation device 20 in the first to third embodiments. The estimation device 20 includes a control device 301, a main storage device 302, an auxiliary storage device 303, a display device 304, an input device 305, and a communication device 306. The control device 301, the main storage device 302, the auxiliary storage device 303, the display device 304, the input device 305, and the communication device 306 are connected through a bus 310.

The display device 304, the input device 305, and the communication device 306 are not necessarily included. For example, when the estimation device 20 is connected to another device, the display function, the input function, and the communication function of the other device may be used.

The control device 301 executes a computer program loaded from the auxiliary storage device 303 to the main storage device 302. The control device 301 is, for example, one or more processors such as CPU. The main storage device 302 is a memory such as read only memory (ROM) and RAM. Examples of the auxiliary storage device 303 include a memory card and a hard disk drive (HDD).

The display device 304 displays information. The display device 304 is, for example, a liquid crystal display. The input device 305 accepts input of information. The input device 305 is, for example, a hardware key. The display device 304 and the input device 305 may be a liquid crystal touch panel serving as the display function and the input function. The communication device 306 communicates with other devices.

The computer program executed in the estimation device 20 is stored in a computer-readable recording medium such as a CD-ROM, a memory card, a CD-R, and a digital versatile disc (DVD) in an installable or executable file format and provided as a computer program product.

The computer program executed in the estimation device 20 may be stored on a computer connected to a network such as the Internet and downloaded via the network. The computer program executed by the estimation device 20 may be provided via a network such as the Internet, without downloading.

The computer program executed in the estimation device 20 may be embedded in, for example, a ROM in advance.

The computer program executed in the estimation device 20 has a module configuration including functions that can be implemented by a computer program, of the functions of the estimation device 20.

The functions implemented by a computer program may be loaded to the main storage device 302 by the control device 301 reading and executing the computer program from a storage medium such as the auxiliary storage device 303. That is, the functions implemented by a computer program are generated on the main storage device 302.

Some of the functions of the estimation device 20 may be implemented by hardware such as IC. The IC is, for example, a processor that executes dedicated processing.

When the functions are implemented using a plurality of processors, each processor may implement one of the functions or may implement two or more of the functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An estimation device comprising:
one or more hardware processors configured to function as:
an acquisition unit configured to acquire an image captured by a camera;
a first estimation unit configured to estimate first estimation information indicating at least one of a position and a pose of the camera from the image;
a first calculation unit configured to calculate first reliability indicating reliability of the first estimation information;
a second estimation unit configured to estimate second estimation information indicating at least one of the position and the pose of the camera;
a second calculation unit configured to calculate second reliability indicating reliability of the second estimation information; and
a determination unit configured to decide at least one of the position and the pose of the camera from the first estimation information and the second estimation information, based on the first reliability and the second reliability, and output the decided at least one of the position and the pose as a determination process result, wherein
the second estimation unit estimates the second estimation information based on a past determination process result by the determination unit.

2. The estimation device according to claim 1, wherein the second estimation unit performs estimation by applying Kalman filtering to the past determination process result and performing linear interpolation of at least one of the position and the pose of the camera at present.

3. The estimation device according to claim 1, wherein
the determination unit
determines at least one of the position and the pose of the camera by using the first estimation information when the first reliability is larger than a first threshold,
determines at least one of the position and the pose of the camera by using the second estimation information when the first reliability is equal to or smaller than the first threshold and the second reliability is larger than a second threshold, and
does not output the determination process result when the first reliability is equal to or smaller than the first threshold and the second reliability is equal to or smaller than the second threshold.

4. The estimation device according to claim 1, wherein when the first reliability is larger than a first threshold and the second reliability is larger than a second threshold, the determination unit decides at least one of the position and the pose of the camera by at least one of new position and pose obtained by integrating the first estimation information and the second estimation information.

5. The estimation device according to claim 4, wherein the determination unit integrates a translation component of the camera included in the first estimation information and a translation component of the camera included in the second estimation information by weighted mean based on the first reliability and the second reliability.

6. The estimation device according to claim 4, wherein the determination unit integrates a rotation component of the camera included in the first estimation information and a rotation component of the camera included in the second estimation information by spherical linear interpolation based on the first reliability and the second reliability.

7. The estimation device according to claim 1, wherein the one or more hardware processors are configured to further function as:
a third estimation unit configured to estimate third estimation information indicating at least one of the position and the pose of the camera from the image, using an estimation method differing from the second estimation unit; and
a third calculation unit configured to calculate third reliability indicating reliability of the third estimation information, wherein
the determination unit decides at least one of the position and the pose of the camera from the first to third estimation information, and further based on the third reliability.

8. The estimation device according to claim 7, wherein the first to third reliability is calculated based on at least one of a value of a rotation component of the pose of the camera and the amount of movement of a translation component of the camera.

9. The estimation device according to claim 7, wherein the one or more hardware processors are configured to further function as a storage control unit configured to:
store the determination process result when any of the first to third reliability is larger than a determination threshold;
discard the determination process result determined this time when all of the first to third reliability is equal to or smaller than the determination threshold and an interval for which at least one of the position and the pose of the camera is not updated is within a valid interval for which the determination process result previously stored is valid; and
store the determination process result determined this time when all of the first to third reliability is equal to or smaller than the determination threshold and the interval for which at least one of the position and the pose of the camera is not updated exceeds the valid interval.

10. An estimation method performed by a computer and comprising:
acquiring an image captured by a camera;
estimating first estimation information indicating at least one of a position and a pose of the camera from the image;
calculating first reliability indicating reliability of the first estimation information;
estimating second estimation information indicating at least one of the position and the pose of the camera;
calculating second reliability indicating reliability of the second estimation information; and
deciding at least one of the position and the pose of the camera from the first estimation information and the second estimation information, based on the first reliability and the second reliability, and outputting the decided at least one of the position and the pose as a determination process result, wherein
the estimating of the second estimation information is performed based on a past determination process result at the deciding.

11. A computer program product having a computer readable medium including programmed instructions, wherein the instructions, when executed by a computer, cause the computer to perform:
acquiring an image captured by a camera;
estimating first estimation information indicating at least one of a position and a pose of the camera from the image;
calculating first reliability indicating reliability of the first estimation information;
estimating second estimation information indicating at least one of the position and the pose of the camera;
calculating second reliability indicating reliability of the second estimation information; and
deciding at least one of the position and the pose of the camera from the first estimation information and the second estimation information, based on the first reliability and the second reliability, and outputting the decided at least one of the position and the pose as a determination process result, wherein
the estimating of the second estimation information is performed based on a past determination process result at the deciding.
